(19) United States
(12) Patent Application Publication
(10) Pub. No.: US 2002/0076251 A1
(43) Pub. Date: Jun. 20, 2002

(54) Recording media driving device for a printing machine

(76) Inventors: Te-Jung Hsu, Chia-I Hsien (TW); Ching-Shin Shiau, Tai-Nan Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 09/683,312

(22) Filed: Dec. 13, 2001

(30) Foreign Application Priority Data
Dec. 15, 2000 (TW) 089126862

(51) Int. Cl. B41J 13/03

(52) U.S. Cl. 400/637

(57) ABSTRACT

A printing machine has a recording device and an operating area located below the recording device. The recording media driving device includes a feed roller on one side of the operating area, a discharge roller on the other side of the operating area, a feed roller pulley installed on one side of the feed roller and having an axis that is effectively equivalent to an axis of the feed roller, a discharge roller pulley installed on one side of the discharge roller and having an axis that is effectively equivalent to an axis of the discharge roller, and a belt coupling the feed roller pulley with the discharge roller pulley. The belt may slip on the discharge roller belt roller such that paper will not be torn or wrinkled while the recording media is delivered and stretched by a feed roller and a discharge roller.

### BACKGROUND OF INVENTION

1. Field of the Invention

The present invention relates to a recording media driving device, and more particularly, to a recording media driving device which can prevent a recording media from being wrinkled.

2. Description of the Prior Art

Please refer to FIG. 1. FIG. 1 is a side view of a prior art recording media driving device 10. The recording media driving device 10 comprises a recording device 11, a feed pinch roller 14, a discharge pinch roller 16, a feed roller 18, a discharge roller 22, and a gear set 24, such that the device 10 can deliver a recording media, such as a sheet of paper 12. The paper 12 is jointly held by the feed clipping roller 14, the feed roller 18, the discharge clipping roller 16, and the discharge roller 22. The recording media driving device 10 is driven by a motor. The motor drives the feed roller 18, which in turn drives the discharge roller 22 through the gear set 24. To prevent the paper 12 from being wrinkled while being delivered by the recording media driving device 10, the rotation speed of the discharge roller 22 is designed to be a little faster than the rotation speed of the feed roller 18. In this manner, the paper 12 is stretched flat and also will not be interfered with the recording media driving device 11.

Please refer to FIG. 2. FIG. 2 is a side view of an alternative prior art recording media driving device 30. Similar to the recording media driving device 10, the recording media driving device 30 comprises a recording device 31, a feed pinch roller 34, a discharge pinch roller 36, a feed roller 38, and a discharge roller 42. But, instead of the gear set 24 of the device 10, the device 30 comprises a timing belt 44 and a pressure idle wheel 46. Through the timing belt 44, the feed roller 38 drives the discharge roller 42. The pressure idle wheel 46 provides tension to the timing belt 44 by pressing against the timing belt 44. The rotation speed of the discharge roller 42 is designed to be a little faster than the rotation speed of the feed roller 38 for the same reasons mentioned previously.

The two recording media driving devices 10, 30 mentioned above utilize the gear set 24 and the timing belt 44 to transfer power to the discharge rollers 22, 42 from the feed rollers 18, 38. The two prior arts keep the rotation speeds of the discharge rollers 22, 42 to be constant and higher than the rotation speeds of the feed rollers 18, 38. In a case where the paper 12, 32 has a thicker thickness and a larger tenacity, the discharge rollers 22, 42 or the feed rollers 18, 38 tend to slip around the back of paper 12, 32 which cannot be evened, thus the paper 12, 32 is possibly damaged and surfaces of the discharge rollers 22, 42 are worn. For a case where the paper 12, 32 has a thinner thickness and a smaller tenacity, as the paper 12, 32 with wet ink is pulled by the discharge rollers 22, 42, the paper 12, 32 is likely to be wrinkled and torn.

### SUMMARY OF INVENTION

It is therefore a primary objective of the claimed invention to provide a recording media driving device for a printing machine to solve the above-mentioned problems.

According to the claimed invention, a recording media driving device for a printing machine is provided. The printing machine comprises a recording device for recording information on a recording media, and an operating area in which the recording device records the information on the recording media. The driving device comprises a feed roller on one side of the operating area for feeding the recording media into the operating area, a discharge roller on the other side of the operating area for removing the recording media from the operating area, a feed roller pulley connected with the feed roller, a discharge roller pulley connected with the discharge roller, and a belt for coupling the feed roller pulley with the discharge roller pulley. A friction between the feed roller pulley and the belt is greater than a friction between the discharge roller pulley and the belt. The discharge roller pulley may slide against the belt when the recording media is pulled to a critical force by the feed roller and the discharge roller.

It is an advantage of the claimed invention that it can prevent a recording media from being stretched over a critical force, so that the recording media will not be torn or wrinkled. Since the claimed invention comprises a toothless belt used as the belt and since the amount of the critical force can be determined by the material of the toothless belt, the coarseness of a surface of the toothless belt and the friction area between toothless belt and pulley, therefore the device is equivalent to a torque limiter. Consequently, as the toothless belt is used to transfer power from the feed roller to the discharge roller, the recording media driving device of the present invention is cheaper and easier to be manufactured.

These and other objectives of the present invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a side view of a prior art recording media driving device.

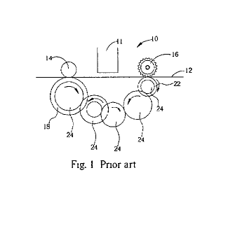

FIG. 2 is a side view of an alternative prior art recording media driving device.

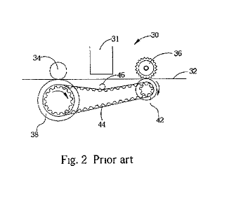

FIG. 3 is a side view of a recording media driving device according to a first embodiment of the present invention.

FIG. 4 is a sectional view of a feed roller pulley and a discharge roller pulley shown in FIG. 3.

FIG. 5 is a perspective view of a feed roller pulley and a discharge roller pulley shown in FIG. 3 according to a second embodiment of the present invention.

FIG. 6 is a perspective view of a feed roller pulley and a discharge roller pulley shown in FIG. 3 according to a third embodiment of the present invention.

FIG. 7 is a perspective view of a feed roller pulley and a discharge roller pulley shown in FIG. 3 according to a fourth embodiment of the present invention.

### DETAILED DESCRIPTION

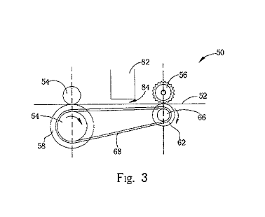

Please refer to FIG. 3. FIG. 3 is a side view of a recording media driving device 50 according to a first embodiment of the present invention. The recording media driving device 50 is applied to a printing machine. The printing machine comprises a recording device 82 that records information onto a recording media 52, and an operating area 84 formed below the recording device 82 in which the recording device 82 records the information on the recording media 52. In the first embodiment, the printing machine is a printer, the recording device 82 is a print head, and the recording media 52 is paper. The print head 82 performs the printing process in the operating area 84.

As shown in FIG. 3, the recording media driving device 50 comprises a feed roller 58 on one side of the operating area 84 for feeding the paper 52 into the operating area 84, a discharge roller 62 on the other side of the operating area 84 for removing the paper 52 from the operating area 84, a feed pinch roller 54 in contact with the feed roller 58, a discharge pinch roller 56, such as a spurs or a star wheels, in contact with the discharge roller 62, a feed roller pulley 64 installed on one side of the feed roller 58 and having an axis that is effectively equivalent to an axis of the feed roller 58, and a discharge roller pulley 66 installed on one side of the discharge roller 62 and having an axis that is effectively equivalent to an axis of the discharge roller 62. The driving device 50 comprises a toothless flat belt 68 for coupling the feed roller pulley 64 with the discharge roller pulley 66. The belt 68 transfers power, which was generated by a motor, from the feed roller 58 to the discharge roller 62. To prevent the paper 52 from being warped while driven by the media recording driving device 50, the rotation speed of the discharge roller 62 is designed to be a little higher than the rotation speed of the feed roller 58, such that the paper 52 is stretched to be flat and at the same time the paper will not be interfered with the print head 82 in order to avoid the smear on paper 52.

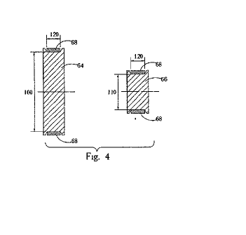

Please refer to FIG. 4. FIG. 4 is a sectional view of a feed roller pulley 64 and a discharge roller pulley 66 shown in FIG. 3. The diameter 110 of the discharge roller pulley 66 is smaller than the diameter 100 of the feed roller pulley 64, such that the rotation speed of the discharge roller pulley 66 is higher than the rotation speed of the feed roller pulley 64.

The contact area between the toothless belt 68 and the feed roller pulley 64 is larger than the area between the toothless belt 68 and the discharge roller pulley 66. Therefore the friction induced by the interaction between the toothless belt 68 and the feed roller pulley 64 is greater than the friction between the toothless belt 68 and the discharge roller pulley 66. When the paper 52 is stretched to a critical force by the feed roller 58 and the discharge roller 62, the toothless flat belt 68 will begin to slip on the discharge roller pulley 66. The critical force can be controlled by the friction between the discharge roller pulley 66 and the belt 68 such that the paper 52 is prevented from being torn.

Though the belt 68 begins to slip on the discharge roller pulley 66, the feed roller 58 still continues to feed the paper 52 toward the discharge roller 62. At this time, the high stretching tension on the paper 52 disappears, the toothless belt 68 stops slipping on the discharge roller pulley 66 and re-stretches the paper 52 again until the paper tension reaches the critical force, and then the belt 68 begins to slip again. Such a process comes into a dynamic equilibrium that keeps the paper stretched under a constant tension, that is, the critical force. Under this critical force, the paper will not be torn nor will it interfere with the print head 82.

In summary, the toothless flat belt 68 will begin to slip on the discharge roller pulley 66 if the friction between the belt 68 and the discharge roller pulley 66 exceeds a critical value (called a critical friction). This critical friction is determined by the groove type of the discharge roller pulley 66, characteristics of the belt, surface coarseness of the toothless belt and contact area between the discharge roller pulley and the toothless belt. The critical force is determined by this critical frictional force, a high critical frictional force corresponding to a high critical force.

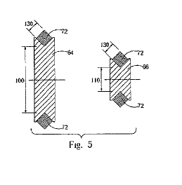

Increasing the width 120 of the toothless belt 68 can increase the critical force because wider belt corresponds to higher critical friction, and higher criticalfriction corresponds to higher critical forcePlease refer to FIG. 5. FIG. 5 is a perspective view of a feed roller pulley 64 and a discharge roller pulley 66 shown in FIG. 3 according to a second embodiment of the present invention. The second embodiment is the same as the first embodiment mentioned above, except for a toothless square belt 72 and the V shaped belt-groove formed on the feed roller pulley 64 and a discharge roller pulley 66. The diameter 110 of the discharge roller pulley 66 is smaller than the diameter 100 of the feed roller pulley 64, such that the friction induced by the interaction between the toothless square belt 72 and the feed roller pulley 64 is greater than the friction between the toothless square belt 72 and the discharge roller pulley 66. Therefore, when the paper 52 shown in FIG. 3 is stretched by both the feed roller 58 and the discharge roller 62 and reaches a critical force, the toothless square belt 72 will begin to slip on the discharge roller pulley 66, such that the paper 52 is prevented from being torn.

Though the belt 72 begins to slip on the discharge roller pulley 66, the feed roller 58 still continues to feed the paper 52 toward the discharge roller 62. At this time, the high stretching tension on the paper 52 disappears, the belt 72 stops slipping on the discharge roller 62 and re-stretches the paper 52 again until the paper tension reaches the critical force, and then the belt 68 begins to slip again. Such a process comes into a dynamic equilibrium that keeps the paper stretched under a constant tension, that is, the critical force of the paper. Under this critical force, the paper will not be torn nor will it interfere with the print head 82. Additionally, in the second embodiment, a width of the toothless square belt 72 can also be used to adjust an amount of the critical force.

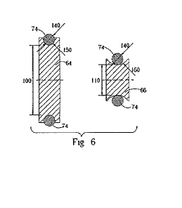

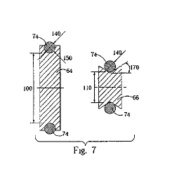

Please refer to FIG. 6. FIG. 6 is a perspective view of a feed roller pulley 64 and a discharge roller pulley 66 shown in FIG. 3 according to a third embodiment of the present invention. The third embodiment is the same as the first embodiment mentioned above, except for a toothless round belt 74, and a round shaped belt-groove on the belt rollers 64, 66. Please refer to FIG. 7. FIG. 7 is a perspective view of a feed roller pulley 64 and a discharge roller pulley 66 shown in FIG. 3 according to a fourth embodiment of the present invention. The fourth embodiment is the same as the third embodiment mentioned above, except for a V-shaped belt-groove on the discharge roller pulley 66.

In the third and fourth embodiments, as described previously in the first embodiment, the friction induced by the interaction between the toothless round belt 74 and the feed roller pulley 64 is greater than the force between the toothless round belt 74 and the discharge roller pulley 66. Therefore, when the paper 52 shown in FIG. 3 is stretched by both the feed roller 58 and the discharge roller 62 and reaches a critical force, the toothless round belt 74 will begin to slip on the discharge roller pulley 66, such that the paper 52 is prevented from being torn.

In contrast to the prior art, the recording media driving device according to the present invention can prevent a recording media from being stretched over of the maximum internal tension of paper. When the paper is stretched to the critical force, the belt begins to slip on the discharge roller pulley, so that the paper tension will not exceed the maximum internal tension of the paper, thus preventing the paper from being torn or wrinkled. The critical force of the paper corresponds to the critical friction at the interface between the toothless belt and the discharge roller pulley. The critical friction can be determined or controlled by the shape of the groove of the discharge roller pulley, characteristics of the belt, coarseness of the belt surface, and contact area between the discharge roller pulley and the toothless belt. The feature mentioned above works as a torque limiter. Also, the toothless belt is much cheaper than a gear set or a timing belt, and is much easier to be assembled. Production costs are therefore reduced.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A recording media driving device for a printing machine, the printing machine comprising a recording device for recording information on a recording media, and an operating area in which the recording device records the information on the recording media, the driving device comprising:
a feed roller on one side of the operating area for feeding the recording media into the operating area;
a discharge roller on the other side of the operating area for removing the recording media from the operating area;
a feed roller pulleyassembled with the feed roller;
a discharge roller pulleyassembled with the discharge roller; and
a belt for coupling the feed roller pulley with the discharge roller pulley;
wherein a friction between the feed roller pulley and the belt is greater than a friction between the discharge roller pulley and the belt, the discharge roller pulley sliding against the belt when the recording media is pulled to a critical force by the feed roller and the discharge roller.

2. The recording media driving device of claim 1 wherein the printing machine is a printer and the recording device is a printing head for printing information on the recording media.

3. The recording media driving device of claim 1 wherein the recording media is paper.

4. The recording media driving device of claim 1 wherein the feed roller pulley is installed on one side of the feed roller and has an axis that is effectively equivalent to an axis of the feed roller.

5. The recording media driving device of claim 1 wherein the discharge roller pulley is installed on one side of the discharge roller and has an axis that is effectively equivalent to an axis of the discharge roller.

6. The recording media driving device of claim 1 wherein the belt transmits force from the feed roller to the discharge roller.

7. The recording media driving device of claim 1 further comprising a feed pinch roller in contact with the feed roller, and a discharge pinch roller in contact with the discharge roller.

8. The recording media driving device of claim 7 wherein the discharge pinch roller is a spur or a star wheel.

9. The recording media driving device of claim 1 wherein the belt is a toothless flat belt.

10. The recording media driving device of claim 9 wherein a width of the toothless flat belt is used to adjust an amount of the critical force.

11. The recording media driving device of claim 1 wherein the belt is a toothless square belt.

12. The recording media driving device of claim 11 wherein a width of the toothless square belt is used to adjust the amount of the critical force.

13. The recording media driving device of claim 1 wherein the belt is a toothless round belt.

14. The recording media driving device of claim 13 wherein a radius of the toothless round belt is used to adjust the amount of the critical force.

15. The recording media driving device of claim 1 wherein the amount of the critical force is determined by material of the belt and a degree of surface coarseness of the belt.

16. The recording media driving device of claim 1 wherein a groove is disposed on an outside edge of the discharge roller pulley and the feed roller pulley.
